(19) United States
(12) Patent Application Publication
(10) Pub. No.: US 2026/0021778 A1
(43) Pub. Date: Jan. 22, 2026

(54) VEHICLE FRONT PORTION STRUCTURE

(71) Applicant: TOYOTA JIDOSHA KABUSHIKI KAISHA, Aichi-ken (JP)

(72) Inventor: Masayuki OKANO, Toyota-shi (JP)

(21) Appl. No.: 19/245,410

(22) Filed: Jun. 23, 2025

(30) Foreign Application Priority Data
Jul. 17, 2024 (JP) 2024-114300

(51) Int. Cl. B60R 13/08; B62D 25/14; G10K 11/168

(52) U.S. Cl. CPC B60R 13/083; B62D 25/14; G10K 11/168

(57) ABSTRACT

A vehicle front portion structure includes a dash panel lower, a soundproofing member, a dash silencer, a floor silencer, and a pad member. The dash panel lower is integrally molded with a skeleton portion of a vehicle front portion by casting, and includes ribs at a vehicle interior side. The soundproofing member is disposed along the ribs. The dash silencer is disposed adjacent to a vehicle upper side of the soundproofing member. The floor silencer is disposed adjacent to a vehicle rear side of the soundproofing member. The pad member is disposed adjacent to a vehicle interior side of the soundproofing member.

### CROSS-REFERENCE TO RELATED APPLICATION

This application is based on and claims priority under 35 USC 119 from Japanese Patent Application No. 2024-114300 filed on Jul. 17, 2024, the disclosure of which is incorporated by reference herein in its entirety.

### BACKGROUND

### Technical Field

The present disclosure relates to a vehicle front portion structure.

### Related Art

Japanese Patent Application Laid-Open (JP-A) No. 2003-104242 discloses a structure in which a flat toe board face is formed by installing a pad member at a boundary between a vehicle interior floor and a dash portion.

Incidentally, in a case in which the front module of a vehicle is integrally formed by casting, a dash panel lower is integrally molded with a skeleton portion of a vehicle front portion, and reinforcing ribs are sometimes provided at the dash panel lower. In such a case, compliance with ribs cannot be ensured, even if a dash silencer that covers a dash panel extends down, and noise generated by tires or the like during travel might enter the vehicle interior.

### SUMMARY

The present disclosure provides a vehicle front portion structure capable of suppressing noise from entering a vehicle interior.

A vehicle front portion structure of a first aspect of the present disclosure includes: a dash panel lower that is integrally molded with a skeleton portion of a vehicle front portion by casting, and that includes ribs at a vehicle interior side; a soundproofing member that is disposed along the ribs; a dash silencer that is disposed adjacent to a vehicle upper side of the soundproofing member; a floor silencer that is disposed adjacent to a vehicle rear side of the soundproofing member; and a pad member that is disposed adjacent to a vehicle interior side of the soundproofing member.

In the vehicle front portion structure of the first aspect, a dash panel lower is integrally molded with a skeleton portion of a vehicle front portion by casting. Ribs are formed at a vehicle interior side of the dash panel lower, and the ribs reinforce the integrally molded skeleton portion and dash panel lower.

A pad member for forming a toe board face, on which a foot of an occupant is placed, is disposed at a vehicle interior side of a dash panel lower. However, in a case in which reinforcing ribs are formed at the dash panel lower, there is sometimes insufficient compliance of the pad member with respect to the ribs, resulting in unnecessary gaps between the members. Such gaps enable noise generated outside a vehicle interior to easily enter the vehicle interior.

In contrast thereto, in the vehicle front portion structure of the first aspect, the soundproofing member is disposed along the ribs at the vehicle interior side of the dash panel lower. Further, adjacent to the soundproofing member, a dash silencer is disposed at a vehicle upper side, a floor silencer is disposed at a vehicle rear side, and a pad member is disposed at the vehicle interior side. Therefore, noise entering through the ribs is effectively suppressed by the soundproofing member. This prevents noise from entering the vehicle interior.

A vehicle front portion structure of a second aspect of the present disclosure has the configuration of the first aspect, wherein soundproofing members are respectively disposed at both vehicle width direction side portions of the dash panel lower.

In the vehicle front portion structure of the second aspect, soundproofing members are respectively disposed at both vehicle width direction side portions of the dash panel lower that is positioned in the vicinity of a wheel house. This enables entry of noise generated at a tire during travel to be effectively suppressed.

A vehicle front portion structure of a third aspect of the present disclosure has the configuration of the first aspect or the second aspect, wherein, at a portion at which the soundproofing member and the pad member are adjacent to each other, one of the soundproofing member or the pad member includes a convex portion and another of the soundproofing member or the pad member includes a concave portion, and the convex portion is fitted into the concave portion.

In the vehicle front portion structure of the third aspect, at a portion at which the soundproofing member and the pad member are adjacent to each other, the convex portion that is provided at one of the soundproofing member or the pad member is fitted into the concave portion that is provided at the other of the soundproofing member or the pad member. This enables positional deviation of the pad member with respect to the soundproofing member to be suppressed, and enables the toe board face to be stabilized.

A vehicle front portion structure of a fourth aspect of the present disclosure has the configuration of the first aspect or the second aspect, wherein the soundproofing member and the dash silencer are disposed adjacent to each other in a state in which part of the soundproofing member and part of the dash silencer overlap in a vehicle front-rear direction.

In the vehicle front portion structure of the fourth aspect, the soundproofing member and the dash silencer are disposed adjacent to each other in a state in which part of the soundproofing member and part of the dash silencer overlap in the vehicle front-rear direction. This enables the path length during entry to be increased in a case in which noise enters through gaps between members. This enables noise to be attenuated before noise passes through to the vehicle interior, even in a case in which there are gaps between members. Further, even in a case in which variations have occurred in assembly positions due to dimensional tolerances or the like during assembly of the soundproofing member and the dash silencer, variations in positions can be absorbed due to an overlap margin in the vehicle front-rear direction. Therefore, robustness in the soundproof effect is excellent.

A vehicle front portion structure of a fifth aspect of the present disclosure has the configuration of the first aspect or the second aspect, wherein the soundproofing member and the floor silencer are disposed adjacent to each other in a state in which part of the soundproofing member and part of the floor silencer overlap in a vehicle up-down direction.

In the vehicle front portion structure of the fifth aspect, the soundproofing member and the floor silencer are disposed adjacent to each other in a state in which part of the soundproofing member and part of the floor silencer overlap in the vehicle up-down direction. This enables the path length during entry to be increased in a case in which noise enters through gaps between members. This enables noise to be attenuated before noise passes through to the vehicle interior, even in a case in which there are gaps between members. Further, even in a case in which variations have occurred in assembly positions due to dimensional tolerances or the like during assembly of the soundproofing member and the floor silencer, variations in positions can be absorbed due to an overlap margin in the vehicle front-rear direction. Therefore, robustness in the soundproof effect is excellent.

A vehicle front portion structure of a sixth aspect of the present disclosure has the configuration of the first aspect or the second aspect, wherein the soundproofing member includes: a skin layer that faces the vehicle interior side and that is configured by a rubber material; and an intermediate layer that is disposed along the ribs by deforming following a shape of the ribs.

In the vehicle front portion structure of the sixth aspect, the soundproofing member has a multilayer structure including a skin layer and an intermediate layer, thereby enabling the soundproof effect to be increased. Further, the intermediate layer of the soundproofing member is deformed following the shape of the ribs of the dash panel lower, thereby improving compliance of the soundproofing member with respect to the ribs, and enabling the occurrence of unnecessary gaps between the members to be suppressed.

A vehicle front portion structure of a seventh aspect of the present disclosure has the configuration of the sixth aspect, wherein the intermediate layer is configured by housing a granular cushioning material at an interior of a bag body that is formed of a thin film material.

In the vehicle front portion structure of the seventh aspect, it is possible to enhance compliance of the soundproofing member with respect to the ribs.

A vehicle front portion structure of an eighth aspect of the present disclosure has the configuration of the sixth aspect, wherein: the intermediate layer is configured by a fiber material; and plural notches are formed in a side surface, which faces the ribs, of the intermediate layer.

In the vehicle front portion structure of the eighth aspect, when the soundproofing member is attached, a portion following the ribs can be inhibited from being drawn toward the surrounding fibers, thereby enabling the soundproofing member to have improved compliance with respect to the ribs.

As explained above, the vehicle front portion structure according to the present disclosure can suppress noise from entering the vehicle interior.

### BRIEF DESCRIPTION OF THE DRAWINGS

An exemplary embodiment of the present disclosure will be described in detail based on the following figures, wherein:

FIG. 1 is a cross-section view schematically illustrating a vehicle to which a vehicle front portion structure according to the present exemplary embodiment is applied.

FIG. 2 is an exploded perspective view illustrating, in a partially exploded manner, a soundproof module disposed at a vehicle front portion structure according to the present exemplary embodiment.

FIG. 3 is a cross-section view of a vehicle front portion which schematically illustrates a state taken along line 3-3 in FIG. 2.

FIG. 4 is a cross-section view of a vehicle front portion which illustrates a state taken along line 4-4 in FIG. 2.

FIG. 5 is a cross-section view of a soundproofing member and a dash panel lower which partially illustrates a state taken along line 5-5 in FIG. 3.

FIG. 6 is a cross-section view schematically illustrating a first modified example of a soundproofing member according to the present exemplary embodiment.

### DETAILED DESCRIPTION

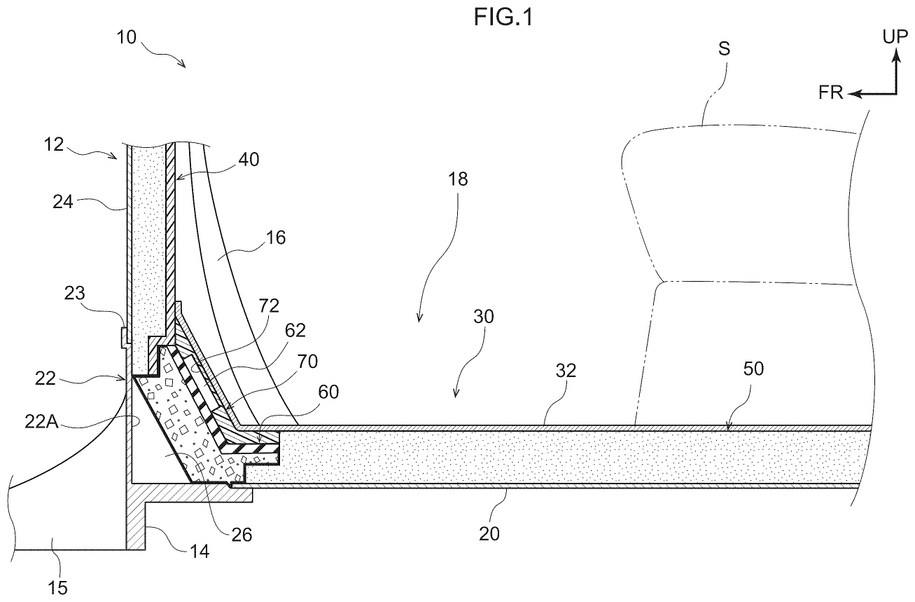

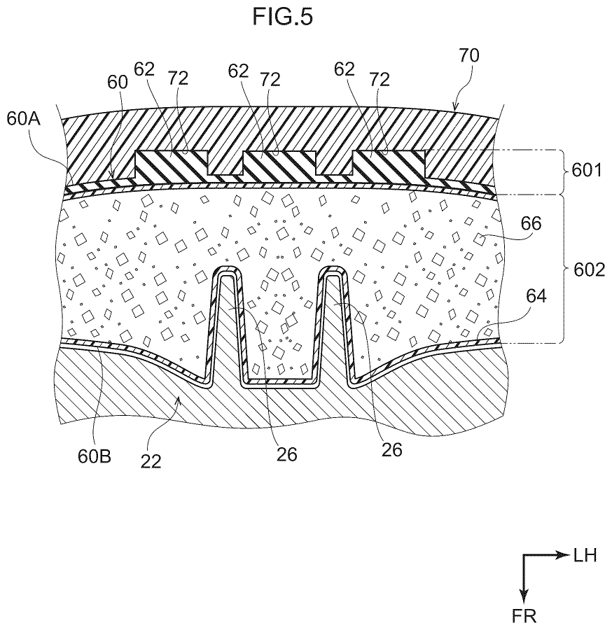

Explanation follows regarding a vehicle front portion structure 10 according to the present exemplary embodiment, with reference to FIG. 1 to FIG. 6. It should be noted that in each of the drawings, as appropriate, the arrow FR indicates a vehicle front side, the arrow UP indicates a vehicle upper side, and the arrow LH indicates a vehicle left side. Further, unless specifically stated otherwise, in the following explanation, reference to front and rear, up and down, and left and right directions refers to the front and rear in a vehicle front-rear direction, up and down in a vehicle up-down direction, and the left and right in a case of facing a direction of travel, respectively.

It should be noted that unless specifically stated otherwise in the specification, each element is not limited to a single element, and there may be a plural number of each element. Further, in the drawings, the same reference numerals are appended to substantially the same elements, and duplicate explanation thereof is omitted in the specification.

### Overview of Vehicle Front Portion

FIG. 1 is a cross-section view that schematically illustrates a front portion of a vehicle 12 to which a vehicle front portion structure 10 according to the present exemplary embodiment is applied. The vehicle 12 in the present exemplary embodiment is, for example, an electric vehicle that travels using driving force of an electric motor that is not illustrated in the drawings. Examples of the electric vehicle include a hybrid electric vehicle (HEV), a plug-in hybrid electric vehicle (PHEV), a battery electric vehicle (BEV), and a fuel cell electric vehicle (FCEV).

As illustrated in FIG. 1, a front cross member 14, serving as a skeleton portion, is disposed at a front portion of the vehicle 12. The front cross member 14 extends long in a vehicle width direction, and both vehicle width direction end portions of the front cross member 14 are connected to lower end portions of a left and right pair of pillars 16. The pillars 16 are disposed at both vehicle width direction side portions as skeleton portions of the vehicle 12. The left and right pillars 16 extend long in a substantially vehicle up-down direction, and upper end sides of the left and right pillars 16 are connected to a front end portion of a roof reinforcement that is not illustrated in the drawings.

A pair of side members 15 configuring a skeleton portion of the vehicle 12 are disposed at a vehicle front side of the front cross member 14. The pair of side members 15 extend long in a substantially vehicle front-rear direction, and are respectively disposed at each vehicle width direction side portion. Rear-side portions of the pair of side members 15 are respectively connected to each vehicle width direction end portion of the front cross member 14. Further, a wheel house, which is not illustrated in the drawings and which houses a front wheel (tire) of the vehicle 12, is integrally molded with a rear-side portion of each of the pair of side members 15.

Further, a pair of rockers, which are not illustrated in the drawings and which configure a skeleton portion of the vehicle 12, are disposed at a vehicle rear side of the front cross member 14. The pair of rockers extend long in a substantially vehicle front-rear direction, and are respectively disposed at each side portion in the vehicle width direction. Front-side portions of the pair of rockers are respectively connected to each vehicle width direction end portion of the front cross member 14. Further, rear-side portions of the pair of rockers are respectively connected to each vehicle width direction end portion of a rear cross member, which is not illustrated in the drawings.

It should be noted that in the vehicle 12, a battery case which is not illustrated in the drawings and in which plural battery stacks are housed, or plural battery stacks are directly supported by a substantially rectangular frame that is formed by the front cross member 14, the rear cross member, and the pair of rockers. Further, note that a battery stack is a module configured by stacking plural battery cells.

A plate-like floor panel 20 that configures a floor of a vehicle interior 18 is supported by a substantially rectangular frame configured by the front cross member 14, the rear cross member, and the pair of rockers. The floor panel 20 is disposed above the battery case or the battery stack, and an outer peripheral portion of the floor panel 20 is connected to the frame. It should be noted that in a case in which the battery case is attached to the frame formed by the front cross member 14, the rear cross member, and the pair of rockers, the floor panel 20 is not essential and may be omitted. In such a case, a floor of the vehicle interior may be configured by an upper surface portion of the battery case.

The front cross member 14, the left and right pair of pillars 16, and the left and right pair of side members 15 are, as an example, each formed using a metal such as an aluminum alloy or a magnesium alloy as a material. Further, the front cross member 14, the left and right pair of pillars 16, and the left and right pair of side members 15 are integrally molded by casting. Therefore, these members each have an open cross-section that is open in at least one of the vehicle front-rear direction, the vehicle up-down direction or the vehicle width direction, corresponding to the extraction direction of the mold of casting. In the example of the present exemplary embodiment, the front cross member 14 has an open cross-section in which a cross-section plane in the vehicle front-rear direction is open at the vehicle rear side and at the vehicle lower side.

It should be noted that it is not essential to integrally mold the front cross member 14, the left and right pair of pillars 16, and the left and right pair of side members 15, and some or all of the members may be formed separately. Further, in a case in which some or all of the members are formed separately, the cross-section shape of each member may be a closed cross-section.

### Dash Panel Lower

A dash panel lower 22 is disposed at a vehicle upper side of the front cross member 14. The dash panel lower 22 supports a dash panel 24 that partitions the vehicle interior 18 at the vehicle front portion and a power unit room that is not illustrated in the drawings. The power unit room is formed at an inner side of the left and right pair of side members 15, and houses a motor or the like that supplies driving force during travel.

The dash panel lower 22 is a plate-like member having a substantially rectangular shape, and for example, is formed using a metal such as an aluminum alloy or a magnesium alloy as a material. The dash panel lower 22 is disposed at an interior of a substantially rectangular frame formed of the front cross member 14, the left and right pair of pillars 16, and a cowl panel that is not illustrated in the drawings and that connects vehicle up-down direction intermediate portions of the left and right pair of pillars 16. An opening portion 23 in a substantially U-shape that is open at the vehicle upper side as seen in a vehicle front-rear direction, for example, is formed in the dash panel lower 22, and the dash panel 24 is attached to the opening portion 23. Plural on-board devices, which are not illustrated in the drawings, and a harness or the like extending from each of the on-board devices are attached to the dash panel 24.

It should be noted that the dash panel lower 22 of the present exemplary embodiment is integrally molded with the front cross member 14 and the left and right pair of pillars 16 by casting. Therefore, the dash panel lower 22 is integrally molded with an upper surface 14A of the front cross member 14, and is erected from the upper surface 14A toward the vehicle upper side. Further, vehicle width direction end portions of the dash panel lower 22 are integrally molded with side surfaces at a vehicle width direction inner side of the left and right pair of pillars 16.

Plural reinforcing ribs 26 are integrally molded with a lower portion of a side surface 22A at a vehicle interior side of the dash panel lower 22. Each rib 26 is connected to the side surface 22A at the vehicle interior side of the dash panel lower 22 and the upper surface 14A of the front cross member 14, and has a substantially triangular shape as seen in the vehicle width direction. Therefore, a connecting portion between the front cross member 14 and the dash panel lower 22 is reinforced by the ribs 26, and a cross-section area of the front cross member 14 is substantially increased at the portions at which the ribs 26 are disposed. Accordingly, the rigidity of the dash panel lower 22 and the front cross member 14 are increased with respect to each other.

In the present exemplary embodiment, plural ribs 26 are respectively provided at a vehicle width direction right side portion and a vehicle width direction left side portion of the dash panel lower 22, and both vehicle width direction side portions of the front cross member 14 are reinforced. Both vehicle width direction side portions of the front cross member 14 are connecting portions to vehicle rear-side portions of the left and right pair of side members 15, and are positioned in the vicinity of the wheel house that is integrally molded with the side members 15. Therefore, by reinforcing both vehicle width direction side portions of the front cross member 14 and the dash panel lower 22 with the ribs 26, transmission of vibration to the dash panel lower 22 is suppressed in a case in which vibration of the front wheel (tire) during travel has been transmitted to the front cross member 14 via the wheel house and the pair of side members 15. This enables noise caused by vibration of the front wheel (tire) during travel to be suppressed.

It should be noted that the above-described configuration of the dash panel lower 22 is merely an example, and is not essential. For example, the dash panel lower 22 may be integrally molded with the front cross member 14, and the pillars 16 may be configured separately. Further, the arrangement of the reinforcing ribs 26 is merely an example, and a configuration may be such that the ribs 26 are provided at a vehicle width direction central portion of the dash panel lower 22.

### Soundproof Module

As illustrated in FIG. 1, a soundproof module 30 for blocking noise generated outside the vehicle interior is disposed at a vehicle interior side of the dash panel 24, the dash panel lower 22, and the floor panel 20.

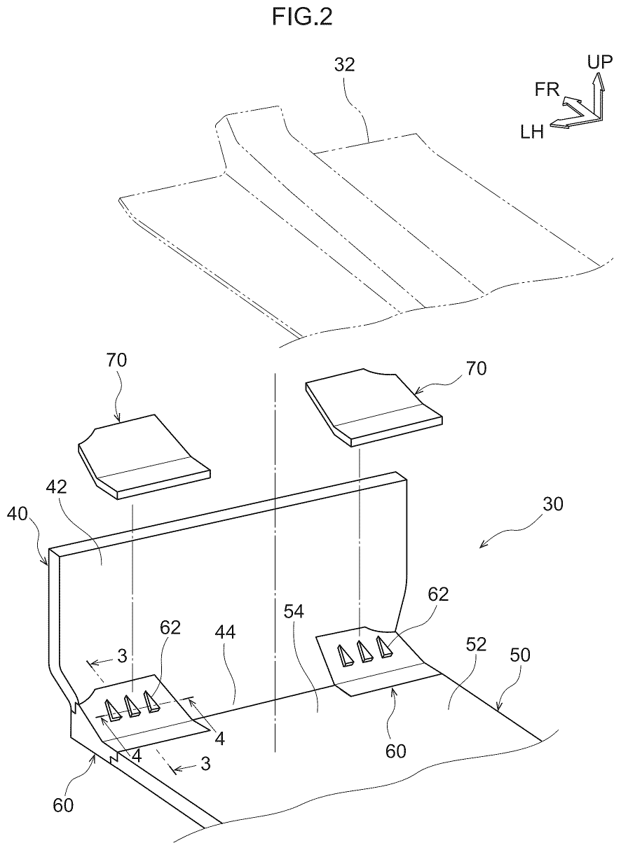

FIG. 2 is an exploded perspective view illustrating the soundproof module 30 in a partially exploded manner. As illustrated in FIG. 2, the soundproof module 30 includes a dash silencer 40, a floor silencer 50, a soundproofing member 60, and a pad member 70. An upper surface of the soundproof module 30 is covered with a separate floor carpet 32 (a skin layer) that configures a design face of a floor of the vehicle interior 18. It should be noted that, as an example, the floor carpet 32 is configured of a carpet skin or a rubber material. The floor carpet 32 may be joined to the floor silencer 50 and integrally configured with the floor silencer 50, or may be separately configured by being mounted on the floor silencer 50 as in the present exemplary embodiment.

### Dash Silencer

The dash silencer 40 is a sheet-shaped member which has sound insulating properties and sound absorbing properties, and which is mainly attached to the entire side surface of the dash panel 24 at the vehicle interior side (covering the side surface of the dash panel 24 at the vehicle interior side).

More specifically, as an example, the dash silencer 40 is substantially T-shaped as seen in the vehicle front-rear direction, and extends in the vehicle width direction and the vehicle up-down direction. As an example, the dash silencer 40 is configured by a base portion 42 that is substantially rectangular in shape and that configures a portion at the vehicle upper side, and by an extending portion 44 that extends toward the vehicle lower side from a vehicle width direction central portion of the base portion 42.

The base portion 42 is disposed straddling the dash panel 24 and a vehicle upper-side portion of the dash panel lower 22, and covers the entire side surface of the dash panel 24 at the vehicle interior side and an upper portion of the side surface 22A of the dash panel lower 22 at the vehicle interior side. Both vehicle width direction side portions of the base portion 42 are adjacent to a vehicle upper side of respective soundproofing members 60, which are described below, at a lower end portion.

The extending portion 44 covers a vehicle width direction central portion of a vehicle lower-side portion of the dash panel lower 22. A lower end portion of the extending portion 44 is adjacent to a front end portion of the floor silencer 50, which is described below. Further, both vehicle width direction end portions of the extending portion 44 are adjacent to a vehicle width direction inner side of the respective soundproofing members 60, which are described below.

### Floor Silencer

The floor silencer 50 is a sheet-shaped member which has sound insulating properties and sound absorbing properties, and which is mainly attached to the entire side surface (upper surface) of the floor panel 20 at the vehicle interior side (covering the side surface of the floor panel 20 at the vehicle interior side).

More specifically, the floor silencer 50 has a substantially rectangular shape as seen in the vehicle up-down direction. As an example, the floor silencer 50 is configured by a base portion 52 that is substantially rectangular in shape and that covers the entire side surface of the floor panel 20 at the vehicle interior side, and an extending portion 54 that extends, at a front-end side of the base portion 52, from a vehicle width direction central portion toward the vehicle front side and the vehicle upper side.

Both vehicle width direction side portions of the base portion 52 are adjacent to a vehicle rear side of the respective soundproofing members 60, which are described later, at a front end portion. Further, both vehicle width direction end portions of the extending portion 54 are adjacent to the vehicle width direction inner side of the respective soundproofing members 60. Furthermore, an upper end portion (a front end portion) of the extending portion 54 is adjacent to a vehicle lower side of the base portion 42 of the dash silencer 40.

### Soundproofing Member

The soundproofing member 60 is a tile-shaped member which has sound insulating properties and sound absorbing properties, and which is mainly disposed so as to cover the plural ribs 26, which are provided at the dash panel lower 22, from the vehicle interior side (to cover the plural ribs 26). Therefore, in the present exemplary embodiment, a left and right pair of soundproofing members 60 are respectively disposed at each vehicle width direction side portion of the dash panel lower 22.

More specifically, the soundproofing member 60 has a substantially rectangular shape as seen in the vehicle front-rear direction, and extends in the vehicle width direction and the vehicle up-down direction. Plural convex portions 62 are formed at a side surface 60A, which faces the vehicle interior side, of the soundproofing member 60. The plural convex portions 62 project out toward the vehicle interior side, and are configured to be fitted into plural concave portions 72 formed at an opposing face of the pad member 70, which is described below. It should be noted that the number of convex portions 62 can be appropriately changed, and may be, for example, one.

As an example, each convex portion 62 has a substantially triangular shape, and tapers toward the vehicle upper side. By making each convex portion 62 tapered, workability and positioning accuracy during assembly can be improved by inserting each convex portion 62 into the concave portion 72 from the tapered end portion.

In the soundproofing member 60, a side surface 60B that faces the dash panel lower 22 has a three-dimensional shape along the ribs 26. In other words, the side surface 60B of the soundproofing member 60, which faces the dash panel lower 22, is disposed along the ribs 26. More specifically, as described below, a bag body 64 that configures an intermediate layer 602 of the soundproofing member 60 is deformed following the shape of the ribs 26. Therefore, the side surface 60B (the bag body 64) facing the dash panel lower 22 is disposed along the ribs 26.

In the present exemplary embodiment, the dash silencer 40 is disposed adjacent to the vehicle upper side (upper end portion) of the soundproofing members 60. Further, the floor silencer 50 is disposed adjacent to the vehicle rear side (lower end portion) of the soundproofing members 60. Furthermore, portions of the dash silencer 40 and the floor silencer 50 are disposed adjacent to the vehicle width direction inner side of the respective soundproofing members 60.

### Pad Member

The pad member 70 is a tile-shaped member that has impact absorbing properties, and is configured of, for example, a foamed resin molded body that is heat-molded by blending a foaming agent in a resin material such as polypropylene resin or polystyrene resin. The pad member 70 is mainly disposed adjacent to a vehicle interior side of the soundproofing member 60. In the present exemplary embodiment, a left and right pair of pad members 70 are respectively disposed so as to cover each of the pair of soundproofing members 60 from the vehicle interior side.

A side surface of the pad member 70 at a vehicle interior side forms a toe board face, on which a foot of an occupant that is seated at a seat S configuring a driver's seat or a passenger seat of the vehicle 12 is placed, and is a flat face. Further, thicknesses of respective portions of the pad member 70 are adjusted so as to form surfaces that are continuous to the dash silencer 40 and the floor silencer 50, which are adjacent to each other.

Plural concave portions 72 corresponding to the plural convex portions 62 that are provided at the soundproofing member 60 are formed at a side surface (a side surface at a vehicle interior outer side) of the pad member 70 facing the soundproofing member 60. The shape of each concave portion 72 is a substantially triangular shape corresponding to the shape of the convex portions 62 of the soundproofing member 60. The plural convex portions 62 provided at the soundproofing member 60 are fitted into the plural concave portions 72, and positional deviation of the pad member 70 with respect to the soundproofing member 60 is suppressed.

### Transmission Loss of Soundproof Module

Next, explanation follows regarding transmission loss (TL) of the soundproof module 30. It should be noted that transmission loss is a value measured using, for example, a difference between sound incident on a material layer such as a wall, and sound that has passed through the material layer and has entered into the vehicle interior (a difference in sound pressure level). Therefore, it is preferable that transmission loss of the soundproof module 30 be greater in terms of improving the soundproofing performance of the vehicle interior 18.

It is known that in cases in which there is a homogeneous single layer material, the value of transmission loss is greater in mass per unit area, and increases with increasing frequency. Therefore, in the soundproof module 30 of the present exemplary embodiment, in a case in which the dash silencer 40, the floor silencer 50, and the soundproofing member 60 are configured of a single layer of material, in order to ensure transmission loss, it is preferable to increase the mass of each member. However, in such a case, there arises a problem in that the weight of the soundproof module is increased when priority is given to ensuring transmission loss.

In contrast, in cases in which the material has a multilayer structure including an air layer, transmission loss is changed by a “spring-mass model” based on a configuration of a material layer (a mass layer) with a large mass and an air layer with a small mass. Namely, there is a characteristic in which resonance occurs at a specific frequency due to the air layer functioning as a spring, and transmission loss becomes large at or above this frequency band.

Further, it is also known that this resonant frequency f₀ is proportional to a value of the square root of the ratio of a spring constant k of the intermediate layer (air layer), at an inner side, with respect to the mass m of the skin layer (mass layer), as illustrated in Formula 1 below, in a case in which vibrations of materials configuring a two-layer configuration are calculated using skin vibrations in the known “spring-mass model”.

$${f}_{0} ∝ \sqrt{\frac{k}{m}} \qquad Formula 1$$

Therefore, in a material with a two-layer structure, from the perspective of improving the soundproofing performance of the vehicle interior 18, a larger mass of the skin layer (mass layer) is preferable, and a smaller spring constant of the intermediate layer (air layer) is preferable.

Due to the above-described characteristics of a multilayer structure material, in the soundproof module 30 of the present exemplary embodiment, the dash silencer 40 and the soundproofing member 60 are configured with a multilayer structure (a two-layer structure in the present exemplary embodiment) material from the perspective of improving soundproofing performance while suppressing weight. It should be noted that the floor silencer 50 of the present exemplary embodiment configures a “spring-mass model” having a multilayer structure (a two-layer structure) together with the floor carpet 32.

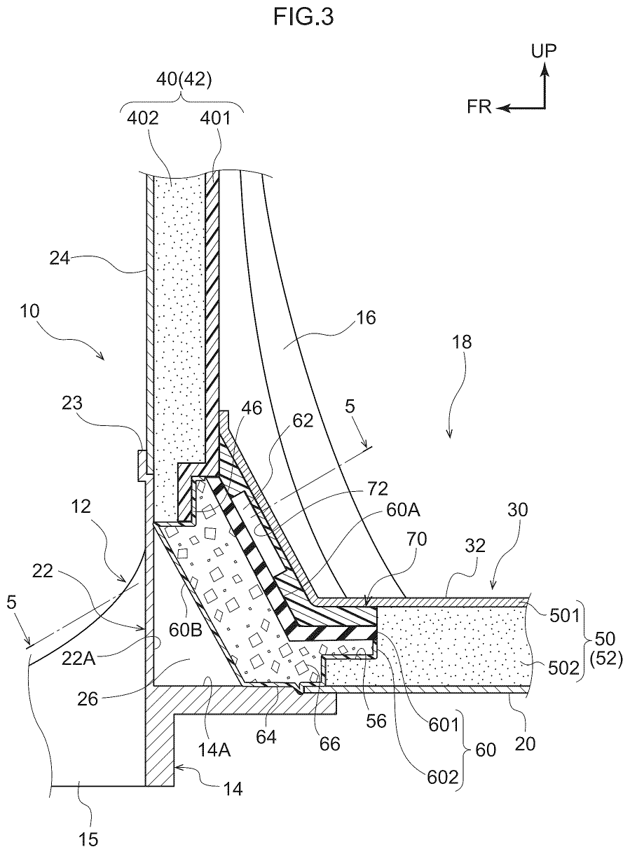

Specifically, as illustrated in FIG. 3, in each of the dash silencer 40 and the floor silencer 50, as an example, skin layers 401 and 501 are configured of a rubber material, and intermediate layers 402 and 502 at an inner side are configured of a fiber material or a urethane material. It should be noted that the skin layer 501 of the floor silencer 50 is configured by the floor carpet 32. There is no particular limitation on the material of the intermediate layers 402 and 502; however, in a case in which the intermediate layers 402 and 502 are formed of a fiber material, including air between fibers results in a layer that has a spring property, like an air layer, in relation to the skin layers 401 and 501. Examples of the fiber material include a felt material, a nonwoven fabric, and the like, and in the present exemplary embodiment, a felt material is adopted.

As illustrated in FIG. 3 to FIG. 5, in the soundproofing member 60, a skin layer 601 is made of a rubber material, and the convex portions 62 are integrally formed with the side surface 60A at the vehicle interior side. The intermediate layer 602 of the soundproofing member 60 is configured by housing a granular cushioning material 66 at an interior of the bag body 64 that is formed of a thin-film material (for example, polyvinyl chloride). The type of the cushioning material 66 is not particularly limited, as long as the cushioning material 66 has a smaller mass per unit volume than the material of the skin layer 601. For example, the cushioning material 66 may be configured of a resin material, wood, a foam material, or the like, and a granular cushioning material formed of plural materials from among these materials may be mixed. Alternatively, waste material may be finely powdered and formed into a granular shape. The intermediate layer 602 includes air between the particles, such that in relation to the skin layer 601, the intermediate layer 602 becomes a layer having a spring property, like an air layer.

It should be noted that in the present exemplary embodiment, in order to improve compliance with the ribs 26 of the dash panel lower 22, the intermediate layer 602 of the soundproofing member 60 has softer properties than the intermediate layers 402 and 502 of the dash silencer 40 and the floor silencer 50.

### Robustness of Soundproof Module

Next, explanation follows regarding the robustness of the soundproof module 30. In light of shielding noise generated outside the vehicle interior, it is preferable that no gaps be formed between the members that configure the soundproof module 30. However, when plural members are assembled, variations in assembly positions may occur due to dimensional tolerances or the like of the respective members, and gaps may be generated between the members.

Therefore, in the soundproof module 30 of the present exemplary embodiment, a configuration is such that respective adjacent members partially overlap each other in a portion in which the soundproofing member 60 and the dash silencer 40 are adjacent to each other, and in a portion in which the soundproofing member 60 and the floor silencer 50 are adjacent to each other.

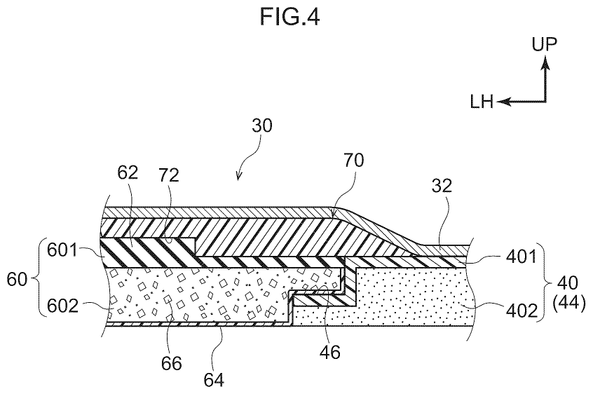

Specifically, in a portion in which the soundproofing member 60 and the dash silencer 40 are adjacent to each other, the soundproofing member 60 and the dash silencer 40 are disposed adjacent to each other in a state in which part of the soundproofing member 60 and part of the dash silencer 40 are overlapped in the vehicle front-rear direction. It should be noted that in the dash silencer 40, lower end portions of both vehicle width direction side portions of the base portion 42 which are adjacent to the respective soundproofing members 60, and vehicle width direction end portions of the extending portion 44 are adjacent to the respective soundproofing members 60. A step portion 46 that faces the vehicle interior side is formed at these end portions of the dash silencer 40, and the plate thickness of the end portions is reduced (see FIG. 3 and FIG. 4). An adjacent end portion of the soundproofing member 60 overlaps with the step portion 46 from the vehicle interior side (the front side), such that end portions of the soundproofing member 60 and the step portion 46 are in a state overlapped with each other in the vehicle front-rear direction. When this occurs, the intermediate layer 602 of the soundproofing member 60 is deformed following the step portion 46 of the dash silencer 40, and is disposed along the step portion 46. Therefore, in the present exemplary embodiment, a side surface of the dash silencer 40 at the vehicle interior side, and a side surface 60A (skin layers 401 and 601) of the soundproofing member 60 at the vehicle interior side, are continuous faces.

Further, the same applies to a portion in which the soundproofing member 60 and the floor silencer 50 are adjacent to each other. The soundproofing member 60 and the floor silencer 50 are disposed adjacent to each other in a state in which part of the soundproofing member 60 and part of the floor silencer 50 are overlapped in the vehicle up-down direction. It should be noted that in the floor silencer 50, front end portions at both vehicle width direction side portions of the base portion 52 which are adjacent to the respective soundproofing member 60, and vehicle width direction end portions of the extending portion 54 are adjacent to the respective soundproofing member 60. A step portion 56 that faces the vehicle interior side is formed at these end portions of the floor silencer 50, and the plate thickness of the end portions is reduced (see FIG. 3). An adjacent end portion of the soundproofing member 60 overlaps at the step portion 56 from the vehicle interior side (the upper side), such that the end portions of the soundproofing member 60 and the step portion 56 are in a state overlapped with each other in the vehicle up-down direction. When this occurs, the intermediate layer 602 of the soundproofing member 60 is deformed following the step portion 56 of the floor silencer 50, and is disposed along the step portion 56. In the present exemplary embodiment, in a state in which the surface of the soundproofing member 60 is covered with the pad member 70, the side surface (the intermediate layer 502) of the floor silencer 50 at the vehicle interior side and the side surface of the pad member 70 at the vehicle interior side are continuous faces.

As described above, each adjacent member is configured to partially overlap with each other, such that in a case in which noise enters through gaps between members, the path length during entry can be increased. Namely, in the present exemplary embodiment, the path length is along the step portions 46 and 56, and is longer than the path length in the case of passing through gaps between straight end faces not including the step portions. This enables noise to be attenuated before noise passes through to the vehicle interior side, even in a case in which there are gaps between members. Further, even in a case in which variations have occurred in assembly positions between members due to dimensional tolerances or the like, variations in positions are absorbed due to overlap margins between end portions, and a configuration is such that gaps are unlikely to occur. Therefore, robustness in the soundproof effect is excellent.

### Operation and Effects

As explained above, in the vehicle front portion structure 10 of the present exemplary embodiment, the dash panel lower 22 is integrally molded with the skeleton portion of the vehicle front portion by casting. Ribs 26 are formed at the vehicle interior side of the dash panel lower 22, and the ribs 26 reinforce the integrally molded skeleton portion and the dash panel lower 22.

Usually, a pad member for forming a toe board face, on which a foot of an occupant is placed, is disposed at the vehicle interior side of a dash panel lower. However, in a case in which the reinforcing ribs 26 are formed at the dash panel lower 22 as in the present exemplary embodiment, there is sometimes insufficient compliance of the pad member with respect to the ribs 26, resulting in unnecessary gaps between the members. Such gaps enable noise generated outside the vehicle interior to easily enter the vehicle interior.

In contrast thereto, in the vehicle front portion structure 10, the soundproofing member 60 is disposed along the ribs 26 at the vehicle interior side of the dash panel lower 22. Further, adjacent to the soundproofing member 60, the dash silencer 40 is disposed at the vehicle upper side, the floor silencer 50 is disposed at the vehicle rear side, and the pad member 70 is disposed at the vehicle interior side. Therefore, noise entering through the ribs 26 is effectively suppressed by the soundproofing member 60. This prevents noise from entering the vehicle interior.

In the present exemplary embodiment, the soundproofing members 60 are respectively disposed at both vehicle width direction sides of the dash panel lower 22 that is positioned in the vicinity of the wheel house. This enables entry of noise generated at a tire during travel to be effectively suppressed.

Further, in the present exemplary embodiment, at a portion at which the soundproofing member 60 and the pad member 70 are adjacent to each other, the convex portions 62 provided at the soundproofing member 60 are fitted into the concave portions 72 provided at the pad member 70. This enables positional deviation of the pad member 70 with respect to the soundproofing member 60 to be suppressed, enabling the toe board face to be stabilized. It should be noted that a configuration may be such that convex portions provided at the pad member are fitted into concave portions provided at the soundproofing member.

In the present exemplary embodiment, the soundproofing member 60 and the dash silencer 40 are disposed adjacent to each other in a state in which part of the soundproofing member 60 and part of the dash silencer 40 are overlapped in the vehicle front-rear direction, and the soundproofing member 60 and the floor silencer 50 are disposed adjacent to each other in a state in which part of the soundproofing member 60 and part of the floor silencer 50 are overlapped in the vehicle up-down direction. Therefore, in a case in which noise enters through gaps between members, the path length during entry becomes longer, enabling noise to be attenuated before noise passes through the gaps. Further, even in a case in which variations have occurred in assembly positions due to dimensional tolerances or the like, variations in positions can be absorbed due to overlap margins between members, thereby providing excellent robustness in the soundproof effect.

### First Modified Example of Soundproof Member

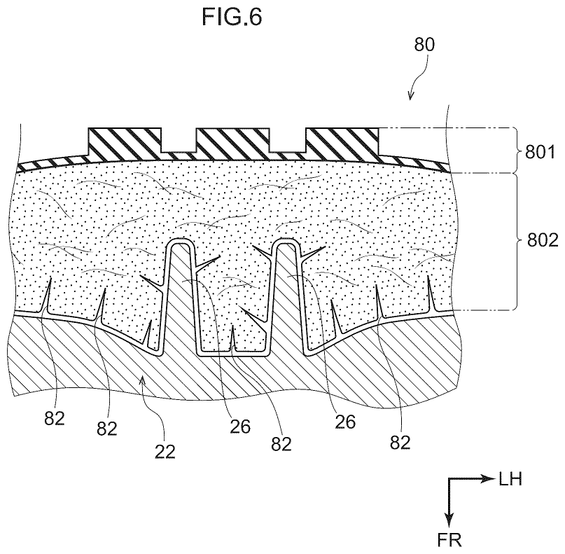

In the above-described exemplary embodiment, the intermediate layer 602 of the soundproofing member 60 is configured such that the granular cushioning material 66 is housed in the bag body 64; however, the present disclosure is not limited thereto. The configuration of a soundproofing member 80 according to the first modified example illustrated in FIG. 6 may be applied. In the soundproofing member 80, similarly to in the case of the dash silencer 40 and the floor silencer 50, a skin layer 801 facing the vehicle interior side is made of a rubber material or the like, and an intermediate layer 802 at an inner side is made of a fiber material such as a felt material or a urethane material. In such cases as well, in a case in which the intermediate layer 802 is made of a fiber material, a urethane material, or the like, including air between fibers or between foam cells enables the intermediate layer 802 to be a layer that has a spring property, like an air layer, in relation to the skin layer 801, thereby enabling transmission loss to be ensured.

Further, in the first modified example, plural notches 82 (cuts) are formed in a side surface, which faces the ribs 26, of the intermediate layer 802 of the soundproofing member 80. This enables a portion following the ribs 26 to be inhibited from being drawn toward the surrounding fibers when the soundproofing member 80 is attached to the side surface 22A of the dash panel lower 22, thereby enabling the soundproofing member 80 to have an improved compliance with respect to the ribs 26.

### Second Modified Example of Soundproof Member

Although not illustrated in the drawings, in a case in which the soundproofing member is configured of a material with a two-layer structure, the skin layer may be configured of a rubber material, and the intermediate layer may be configured of a sponge material such as urethane or of a granular sponge material. In such a case, the soundproofing member can be molded by molding using a mold, thereby enabling the shape of the soundproofing member to be easily molded along the ribs 26.

In the above-described exemplary embodiments, the dash silencer 40, the floor silencer 50, and the soundproofing member 60 are configured of materials with a multilayer structure; however, there is no limitation thereto, and these members may be configured of materials with a single layer structure.

What is claimed is:

1. A vehicle front portion structure, comprising:
a dash panel lower that is integrally molded with a skeleton portion of a vehicle front portion by casting, and that includes ribs at a vehicle interior side;
a soundproofing member that is disposed along the ribs;
a dash silencer that is disposed adjacent to a vehicle upper side of the soundproofing member;
a floor silencer that is disposed adjacent to a vehicle rear side of the soundproofing member; and
a pad member that is disposed adjacent to a vehicle interior side of the soundproofing member.

2. The vehicle front portion structure according to claim 1, wherein soundproofing members are respectively disposed at both vehicle width direction side portions of the dash panel lower.

3. The vehicle front portion structure according to claim 1, wherein, at a portion at which the soundproofing member and the pad member are adjacent to each other, one of the soundproofing member or the pad member includes a convex portion and another of the soundproofing member or the pad member includes a concave portion, and the convex portion is fitted into the concave portion.

4. The vehicle front portion structure according to claim 1, wherein the soundproofing member and the dash silencer are disposed adjacent to each other in a state in which part of the soundproofing member and part of the dash silencer overlap in a vehicle front-rear direction.

5. The vehicle front portion structure according to claim 1, wherein the soundproofing member and the floor silencer are disposed adjacent to each other in a state in which part of the soundproofing member and part of the floor silencer overlap in a vehicle up-down direction.

6. The vehicle front portion structure according to claim 1, wherein the soundproofing member comprises:
a skin layer that faces the vehicle interior side and that is configured by a rubber material; and
an intermediate layer that is disposed along the ribs by deforming following a shape of the ribs.

7. The vehicle front portion structure according to claim 6, wherein the intermediate layer is configured by housing a granular cushioning material at an interior of a bag body that is formed of a thin film material.

8. The vehicle front portion structure according to claim 6, wherein:
the intermediate layer is configured by a fiber material; and
a plurality of notches are formed in a side surface, which faces the ribs, of the intermediate layer.
